(19) United States
(12) Patent Application Publication
(10) Pub. No.: US 2023/0054113 A1
(43) Pub. Date: Feb. 23, 2023

(54) Connector Assembly and Connector

(71) Applicant: Tyco Electronics (Shanghai) Co. Ltd., Shanghai (CN)

(72) Inventors: Qin (Candy) Xu, Shanghai (CN); Hongbo (Daniel) Zhang, Shanghai (CN)

(73) Assignee: Tyco Electronics (Shanghai) Co. Ltd., Shanghai (CN)

(21) Appl. No.: 17/890,344

(22) Filed: Aug. 18, 2022

(30) Foreign Application Priority Data
Aug. 18, 2021 (CN) 202121945130.4

(51) Int. Cl. H01R 12/51; H01R 12/70

(52) U.S. Cl. CPC H01R 12/515; H01R 12/7035

(57) ABSTRACT

A connector assembly comprises a first connector and a second connector. The first connector includes a first housing and first connection terminals. The first housing defines a receiving cavity with an open upper end. A second connector includes a second housing and second connection terminals. The second housing is adapted to be partially inserted into the receiving cavity such that the second connection terminals electrically contact with the first connection terminals. The second housing defines an oblique-insertion restriction structure protruding from a remaining uninserted portion of the second housing. The restriction structure is sized and positioned to abut against an upper end surface of the first housing in a condition in which the second housing is inserted into the receiving cavity in an oblique posture relative to the first housing.

### CROSS-REFERENCE TO RELATED APPLICATIONS

This application claims the priority benefit of Chinese Patent Application No. 202121945130.4 filed on Aug. 18, 2021 in the China National Intellectual Property Administration, the whole disclosure of which is incorporated herein by reference.

### FIELD OF THE INVENTION

The present disclosure relates to an electrical connector, and in particular, to a connector assembly and a connector having a structure for restricting excessive oblique-insertion of the connector during the mating of the connector assembly.

### BACKGROUND

Electrical connectors are commonly used to establish electrical connections between electronic elements, such as cables and circuit boards. Conventional wire-to-board electrical connectors typically adopt a design in which a plug connector and a socket connector mate with each other. During insertion of the plug connector into the socket connector, the plug connector is often initially inserted partially into the socket connector with an oblique attitude. This may be due to limited operation space, or for ease of operation. However, a plug connector that is inserted obliquely cannot align with terminals or pins in the socket connector. Thus, it may cause the terminals or the pins in the socket connector to be bent or skewed, thereby resulting in poor electrical contact.

### SUMMARY

A connector assembly according to an embodiment of the present disclosure comprises a first connector and a second connector. The first connector includes a first housing and first connection terminals. The first housing defines a receiving cavity with an open upper end. A second connector includes a second housing and second connection terminals. The second housing is adapted to be partially inserted into the receiving cavity such that the second connection terminals electrically contact the first connection terminals. The second housing defines an oblique-insertion restriction structure protruding from a remaining uninserted portion of the second housing and sized and positioned to abut against an upper end surface of the first housing as the second housing is inserted into the receiving cavity in an oblique posture relative to the first housing.

### BRIEF DESCRIPTION OF THE DRAWINGS

The invention will now be described by way of example with reference to the accompanying Figures, of which:

FIG. 1 is a side perspective view schematically showing the structure of a connector assembly according to an exemplary embodiment of the present disclosure, wherein (a) shows that a state before a second connector of the connector assembly is assembled to a first connector in an aligned posture, (b) shows a state after the first connector and the second connector of the connector assembly are assembled;

FIG. 2 is another side perspective view schematically showing the structure of a connector assembly according to an exemplary embodiment of the present disclosure, wherein (a) shows that a state before a second connector of the connector assembly is assembled to a first connector in an aligned posture, (b) shows a state after the first connector and the second connector of the connector assembly are assembled;

FIG. 3 is a cross-sectional view schematically showing a structure of a connector assembly according to an exemplary embodiment of the present disclosure, wherein (a) shows that a state before a second connector of the connector assembly is assembled to a first connector in an aligned posture, (b) shows a state after the first connector and the second connector of the connector assembly are assembled;

FIG. 4 is a side perspective view schematically illustrating a process in which the second connector of the connector assembly is inserted into the first connector in an oblique posture, according to an exemplary embodiment of the present disclosure;

FIG. 5 is another side perspective view schematically illustrating a process in which the second connector of the connector assembly is inserted into the first connector in an oblique posture, according to an exemplary embodiment of the present disclosure;

FIG. 6 is a schematic cross-sectional view schematically illustrating a process in which the second connector of the connector assembly is inserted into the first connector in an oblique posture, according to an exemplary embodiment of the present disclosure; and

FIG. 7 is a perspective cross-sectional view schematically illustrating a process in which the second connector of the connector assembly is inserted into the first connector in an oblique posture, according to an exemplary embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Exemplary embodiments in accordance with the present disclosure provide a connector assembly, for example, for electrically connecting a cable 10 to a circuit board, such as a circuit board or control panel disposed within a housing of an electrical apparatus. Such a connector assembly can be used, for example, for electrical connection of various domestic appliances and in-vehicle appliances, and the like.

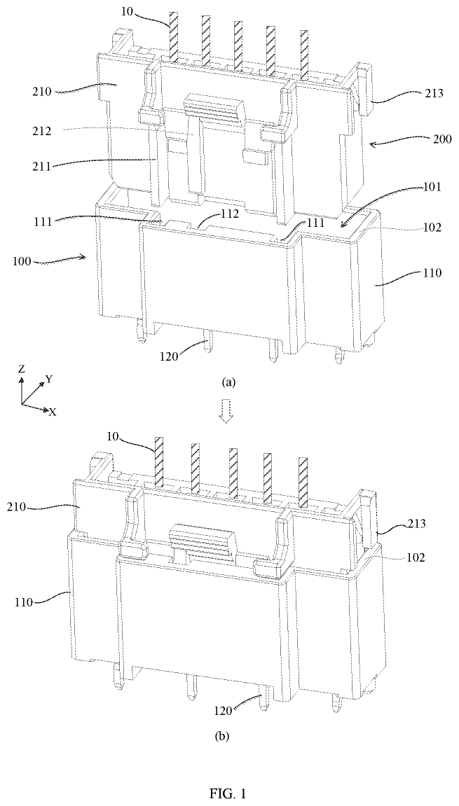

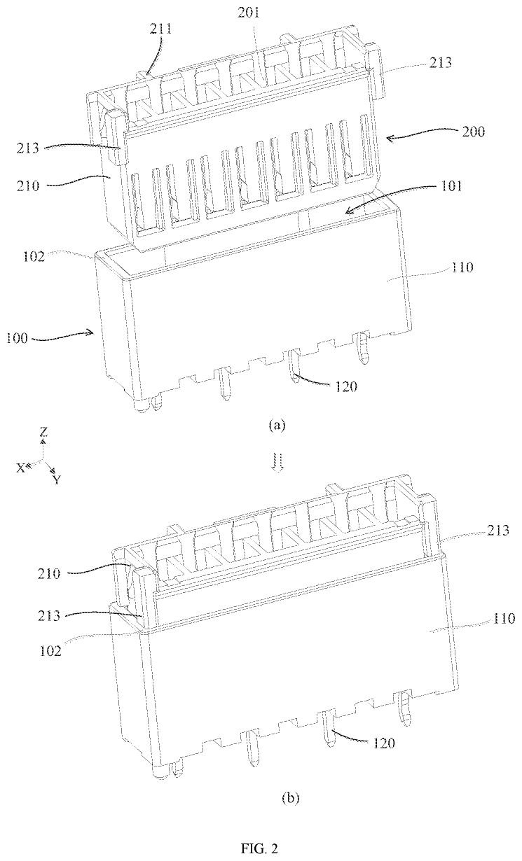

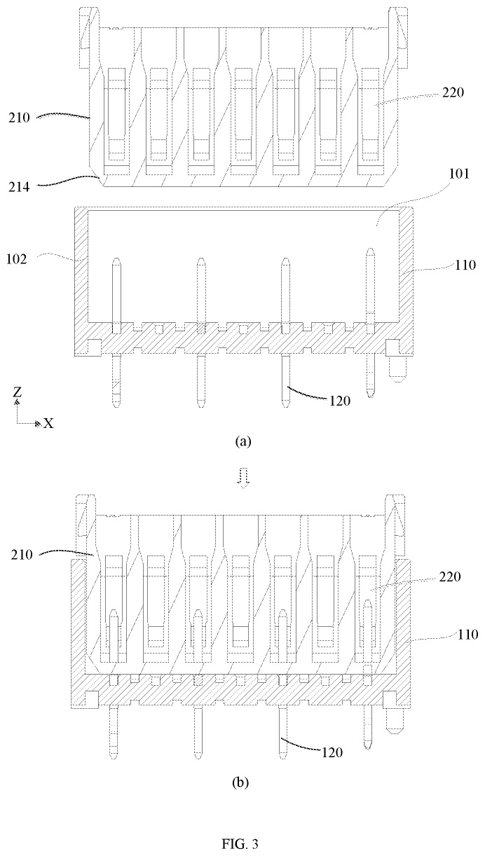

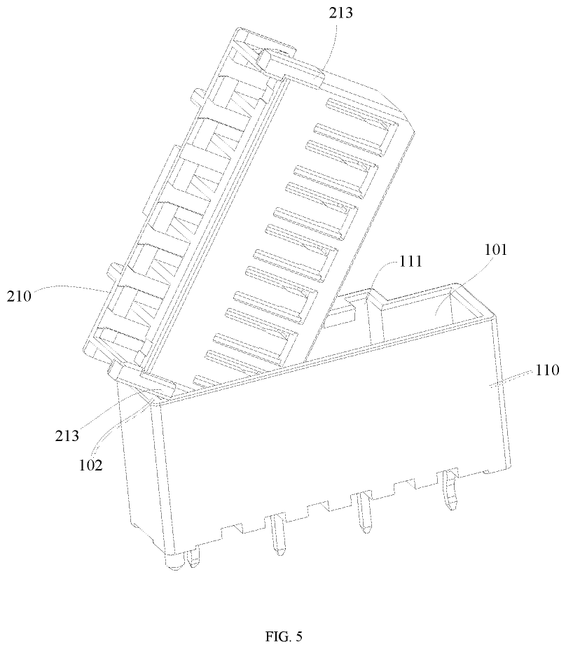

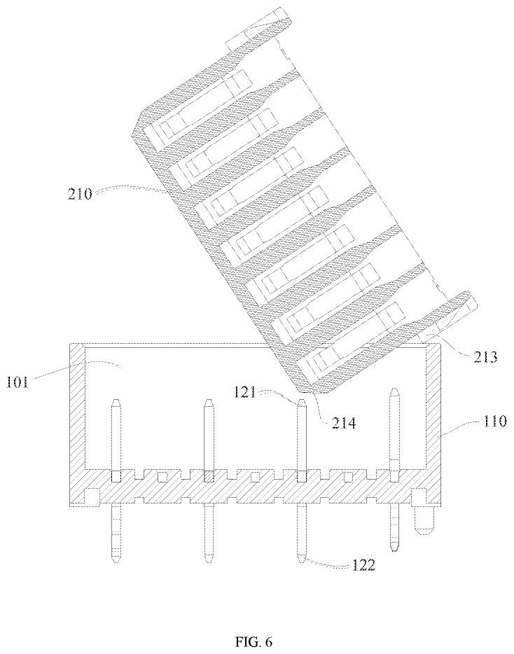

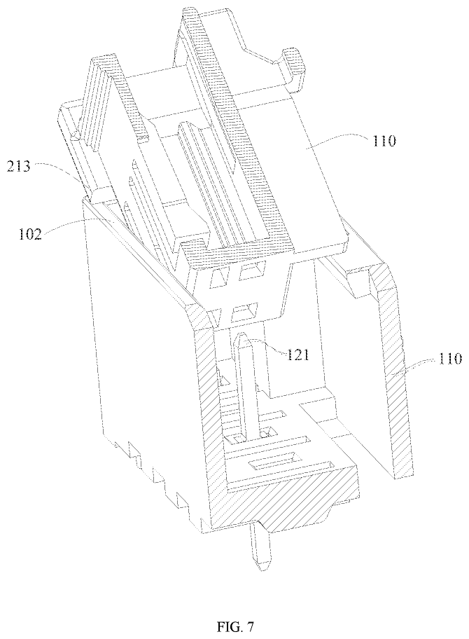

In embodiments as illustrated in FIGS. 1-7, the connector assembly includes a first connector 100 and a second connector 200 adapted to mate with and be electrically connected to each other. The first connector 100 includes a first housing 110 and one or more first connection terminals 120. The first housing 110 includes a receiving cavity 101 opens at its upper end or on a side facing the second connector 200 to receive therein the inserted second connector 200. The first connection terminals 120 are partially disposed inside the first housing 110. For example, the first connection terminals may include signal terminals and/or power terminals adapted to electrically connect to the circuit board. As shown in the figures, one end of the first connection terminal 120 is located in the first housing 110 and configured for electrically connecting with the second connector 200 inserted into the receiving cavity 101. The opposite end of the first connection terminal 120 is exposed from the first housing 110 so as to be electrically connected to the circuit board.

The second connector 200 includes a second housing 210 and one or more second connection terminals 220 disposed in the second housing 210. The second connection terminals 220 are adapted to be electrically connected with the cable 10, for example. The cable 10 can be plugged into the second housing 210 to be electrically connected with the second connection terminals 220. The second housing 210 is adapted to be partially inserted into the receiving cavity 101 of the first housing 110, so that the second connection terminals 220 are in electrical contact with the corresponding first connection terminals 110 for electrically connecting the second connector 200 and the first connector 100.

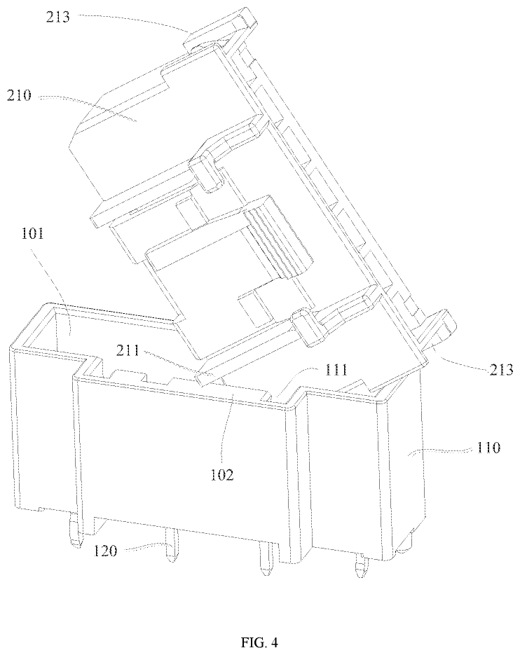

In the illustrated embodiments, the first housing 110 and the second housing 210 each have a length extending in a horizontal direction X, a width extending in a horizontal direction Y, and a height extending in a vertical direction or up-down direction Z. Typically, matching guide structures are provided on the first housing 110 and the second housing 210 so as to properly guide the insertion of the second housing 210 into the receiving cavity 101 of the first housing 110. As an example, as shown in FIGS. 1 and 4, one inner surface of the first housing 110 is formed with first guide grooves 111 extending in the up-down direction Z, and an outer surface of the second housing 210 opposite to the inner surface is formed with first guide ribs 211 corresponding to the first guide grooves 111. The first guide ribs 211 also extend in the up-down direction to be adapted to be guided by and move in the corresponding first guide grooves 111 during the process in which the second housing 210 is inserted into the receiving cavity 101 in an insertion direction, such that the second housing is properly positioned in the receiving cavity 101.

During the assembling, in a manner that the second connector 200 is aligned with the first connector 100, such as in the up-down direction or the vertical direction Z as shown in the figures, the first guide ribs 211 may be aligned with the corresponding first guides grooves 111 in the up-down direction or the vertical direction Z. In this way, the second connector 200 is plugged into the first connector 100 in a correct manner, and a proper connection is realized between the second connection terminals 220 and the corresponding first connection terminals 110. However, in actual operation, due to the limitation of the working environment or operating space or for the convenience of operation, the operator usually makes the second connector 200 in an oblique posture (e.g., deviating from the alignment in the up-down direction or the vertical direction Z) such that the first guide ribs 211 slide on the upper end surface of the first housing 110 to seek the corresponding first guide grooves 111, that is, a pre-insertion or tentative insertion operation is performed. During this seeking process, a portion of the second connector 200 in the oblique posture (e.g., the corner of the second housing 210) moves within the receiving cavity 101, thereby causing the portion of the second housing 210 to enter into the receiving cavity 101 too deeply, which may contact or touch the first connection terminals 120 in the first housing 110. Such contact or touch may cause the first connection terminals 120 to be skewed or bent, which may lead to subsequent poor electrical connection.

Therefore, in the exemplary embodiments according to the present disclosure, the second housing 210 is provided with oblique-insertion restriction structures 213 configured for abutting against the upper end surface of the first housing 110 during a process in which the second housing 210 is inserted into the receiving cavity 101 in the oblique posture relative to the first housing 110. This arrangement prevents the second housing 210 from entering into the receiving cavity 101 too deeply due to the skew. Thus, the second housing 210 is prevented from being inserted obliquely further, so that the second housing 210 in the oblique posture is prevented from contacting or touching the first connection terminals 120 disposed in the first housing 110.

In an exemplary embodiment, a portion, such as the lower portion, of the second housing 210, is adapted to be inserted and positioned in the receiving cavity 101, as shown in parts (b) of FIGS. 1-3. The cable 10 is adapted to be plugged into the second housing 210 from the top of the second housing 210 so as to be electrically connected to the second connection terminals 220. The oblique-insertion restriction structures 213 are provided at the upper portion of the second housing 210. After the lower portion of the second housing 210 is inserted into the receiving cavity 101, or after the second connector 200 is properly assembled to the first connector 100, the oblique-insertion restriction structures 213 are located outside or exposed from the first housing 110.

In some examples, after the lower portion of the second housing 210 is inserted into the receiving cavity 101, or after the second connector 200 is properly assembled to the first connector 100, the oblique-insertion restriction structures 213 can abut against the upper end surface of the first housing 110. Alternatively, the restriction structures 213 are located above, for example directly above, the upper end surface of the first housing 110, so that in some unexpected situations, for example in an case in which the second connector is accidentally touched or squeezed, the second housing 210 is prevented from entering into a too deep position in the receiving cavity 101 of the first housing 110. In this way, damage to the connection terminals or poor contact of the connection terminals caused by displacements is avoided.

As an example, the oblique-insertion restriction structure 213 may include a protruding ridge which extends downwardly for a certain length (for example, this length is smaller than the dimension of the second housing in the up-down direction Z) from the upper end of the second housing 210. The lower end surface of the oblique-insertion restriction structure 213 will abut against the upper end surface of the first housing 110 during the process in which the second housing 210 is inserted into the receiving cavity 101 in the oblique posture relative to the first housing 110.

It will be understood that the position and/or the extended length of the oblique-insertion restriction structure 213 can be set such that during a process in which the second housing 210 is inserted into the receiving cavity 101 in any oblique posture or during a process in which the guide ribs 211 slide on the upper end surface of the first housing 110 while the second housing 210 is in any oblique posture, the oblique-insertion restriction structures 213 abuts against the upper end surface of the first housing 110. In this way, the second housing 210 is ensured to not contact or touch the first connection terminals 120 in the first housing 110. After the first guide grooves 111 are located, the operator can convert the second housing 210 from the oblique posture to a correct posture in which the second housing is aligned with the first housing 110 in the up-down direction Z. In this aligned posture, the second connection terminals 220 in the second housing 210 will align with the corresponding first connection terminals 110 in the first housing 110, so that the first guide ribs 211 enter into the first guide grooves 111, and the second housing 210 is inserted into the receiving cavity 101 of the first housing 110 correctly or in align under the guiding effect of the first guide ribs 211 and the first guide grooves 111 matching each other.

As shown in FIGS. 1-7, the oblique-insertion restriction structures 213 are provided or formed at least at one corner of the upper portion of the second housing 210, for example at two corners of one side of the upper portion of the second housing 210. In the embodiments shown in FIGS. 1, 2, 4, 5 and 7, the oblique-insertion restriction structures 213 are located on one side of the second housing 210 opposite to the first guide ribs 211. For example, the oblique-insertion restriction structure 213 and the first guide ribs 211 are located on the opposite outer surfaces of the second housing 210 in the width direction Y, respectively. In this way, the oblique-insertion restriction structure 213 and the first guide ribs 211 located on the opposite sides of the second housing 210 will slide on the opposite upper end surfaces of the first housing 110 (i.e., the two opposite upper end surfaces in the width direction Y), respectively, during a process in which the second housing 210 is inserted into the receiving cavity 101 in the oblique posture, thereby avoiding a certain portion of the second housing 210 in the width direction Y from being skewed and entering into the receiving cavity 101 too deeply.

In one embodiment, the oblique-insertion restriction structure 213 located at the corner of the upper portion of the second housing 210 may bridge two adjacent outer surfaces of the second housing 210, so that the posture of the second housing 210 can be more stably maintained during the process in which the second housing 210 is pre-inserted into the receiving cavity 101 and after the second housing 210 is inserted into the receiving cavity 101.

Two or more first guide grooves 111 can be formed on the inner surface of the first housing 110, and one second guide groove 112 can be disposed between the two adjacent first guide grooves 111 (see FIGS. 1 and 4). The second guide grooves 112 extend in the up-down direction Z and have different size than the first guide grooves 111, for example, a different width and/or length from those of the first guide grooves 111. Correspondingly, the first guide ribs 211, which correspond to the first guide grooves 111 in a one-to-one relation, and the second guide ribs 212, each of which is located between two adjacent first guide ribs 211, are provided on the outer surface of the second housing 210. The second guide rib 212 also extends in the up-down direction, is positioned at a location corresponding to that of the second guide groove 112 and has a size matching that of the second guide groove 112, so that the second guide rib 212 is adapted to be guided and move in the second guide groove 112 when the second housing 210 is inserted into the receiving cavity 101. The sizes of the second guide groove 112 and the second guide rib 212 are different from those of the first guide grooves 111 and the first guide ribs 211, which can prevent the second housing from being mis-inserted or from being inserted in an inappropriate orientation into the receiving cavity.

In some embodiments the second guide groove 112 is provided at different distances from the two adjacent first guide grooves 111, that is, the second guide rib 212 is provided at different distances from the two adjacent second guide ribs 211. Therefore, it can be ensured that the second housing is guided and inserted into the receiving cavity in the correct posture.

In some embodiments, as shown in FIGS. 1-7, the corner at the lower portion of the second housing 210 is chamfered or has sloped or curved surfaces extending obliquely towards a bottom surface from the side surface of the second housing 210. This arrangement ensures that the corner of the lower portion of the second housing 210 will be prevented from contacting or touching the first connection terminals 120 in the first housing 110 during the process in which the second housing 210 is pre-inserted into the receiving cavity 101 in the oblique posture. It can be understood that the entire corner of the lower portion of the second housing 210 along the width direction Y can be chamfered or formed with a sloped or curved surface. In some examples, by providing the oblique-insertion restriction structure 213 described above and/or the combination of the oblique-insertion restriction structure 213 and such chamfered or sloped corner of the second housing 210, it is possible to make the minimum gap between the corner portion of the lower portion of the second housing 210 and the first connection terminals 120 in the first housing 110 to be 0.19 mm or more during the process in which the housing 210 is pre-inserted into the receiving cavity 101 in any oblique posture.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector assembly, comprising:
a first connector including a first housing and first connection terminals disposed in the first housing, the first housing defining a receiving cavity with an open upper end; and
a second connector including a second housing and second connection terminals disposed in the second housing, the second housing adapted to be partially inserted into the receiving cavity such that the second connection terminals electrically contact with the first connection terminals, the second housing defining an oblique-insertion restriction structure protruding from a remaining uninserted portion of the second housing, and sized and positioned to abut against an upper end surface of the first housing as the second housing is inserted into the receiving cavity in an oblique posture relative to the first housing.

2. The connector assembly according to claim 1, wherein a lower portion of the second housing is adapted to be inserted into the receiving cavity, and the oblique-insertion restriction structure is defined on an upper portion of the second housing that remains exposed after the lower portion of the second housing is inserted into the receiving cavity.

3. The connector assembly according to claim 2, wherein the oblique-insertion restriction structure abuts the upper end surface of first housing or is positioned above the upper end surface of the first housing after the lower portion of the second housing is inserted into the receiving cavity.

4. The connector assembly according to claim 2, wherein the oblique-insertion restriction structure includes a protruding rib extending downwardly from an upper end of the second housing.

5. The connector assembly according to claim 2, wherein the oblique-insertion restriction structure is arranged at least one corner of the upper portion of the second housing.

6. The connector assembly according to claim 1, wherein:
a first guide groove is formed on one inner surface of the first housing at least partially defining the receiving cavity and extends in a vertical direction; and
a first guide rib corresponding to the first guide groove is provided on an outer surface of the second housing opposite the inner surface, the first guide rib extending in the vertical direction so as to be guided by and move within the corresponding first guide groove as the second housing is inserted into the receiving cavity.

7. The connector assembly according to claim 6, wherein the oblique-insertion restriction structure is located on a side of the second housing opposite to the first guide rib.

8. The connector assembly according to claim 7, wherein the oblique-insertion restriction structure and the first guide rib are provided on opposite outer surfaces of the second housing.

9. The connector assembly according to claim 6, wherein:
at least two first guide grooves and a second guide groove are formed on the inner surface of the first housing, the second guide groove being located between two adjacent ones of the first guide grooves, the second guide groove having a different size from the first guide grooves; and
first guide ribs, which correspond to the first guide grooves in a one-to-one relationship, and a second guide rib located between two adjacent ones of the first guide ribs, are provided on the outer surface of the second housing, and the second guide rib extends in the vertical direction and is sized corresponding with the second guide groove so as to be guided and move in the second guide groove as the second housing is inserted into the receiving cavity.

10. The connector assembly according to claim 9, wherein the oblique-insertion restriction structure comprises a pair of oblique-insertion restriction structures formed on a side of the second housing opposite the first and second guide ribs.

11. The connector assembly according to claim 9, wherein the second guide groove is located at a different distance from each of the two adjacent first guide grooves.

12. The connector assembly according to claim 1, wherein a corner of the lower portion of the second housing is chamfered or has a slope extending obliquely from a side surface to a bottom surface of the second housing.

13. A connector, comprising:
a housing having an exterior surface defining a restriction structure protruding therefrom in a width direction of the housing and normal to an insertion direction of the housing into a mating connector, the restriction structure sized and located to abut against a receiving end of the mating connector during a process in which the housing is inserted into the mating connector in an oblique posture relative to the insertion direction.

14. The connector according to claim 13, wherein the restriction structure is formed on an upper end of the housing which is not inserted into the mating connector in a mated state of the connector and the mating connector.

15. The connector according to claim 13, wherein restriction structure includes a protruding rib extending downwardly in the insertion direction from an upper end of the housing.

16. The connector according to claim 13, wherein the restriction structure further protrudes from the exterior surface of the housing in a thickness direction of the housing and normal to the width direction and the insertion direction.

17. A connector assembly, comprising:
a first connector including a first housing defining a receiving cavity having an open end; and
a second connector including a second housing sized to be partially inserted into the receiving cavity, the second housing defining a pair of restriction structures protruding from each lateral side of a portion of the second housing, restriction structures sized and positioned to abut against an upper end surface of the first housing during a process in which the second housing is inserted into the receiving cavity in an oblique posture relative to the first housing.

18. The connector assembly according to claim 17, wherein the pair of restriction structures oppose the upper end surface of the first housing in an insertion direction with the second housing partially inserted into the receiving cavity.

19. The connector assembly according to claim 17, wherein the corner of the lower portion of the second housing has a slope extending obliquely from a side surface to the bottom surface of the second housing.

20. The connector assembly according to claim 17, wherein the restriction structure further protrudes from the housing in a thickness direction and normal to a lateral direction of the housing and an insertion direction of the second connector relative to the first connector.
